(19) United States
(12) Patent Application Publication
(10) Pub. No.: US 2010/0332978 A1
(43) Pub. Date: Dec. 30, 2010

(54) DOCUMENT PROCESSING APPARATUS, DOCUMENT PROCESSING METHOD, DOCUMENT PROCESSING SYSTEM, AND COMPUTER READABLE MEDIUM

(75) Inventor: Toshiya NAKAZAWA, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/639,803

(22) Filed: Dec. 16, 2009

(30) Foreign Application Priority Data
Jun. 25, 2009 (JP) 2009-151009

(51) Int. Cl. G06F 3/14

(52) U.S. Cl. 715/273

(57) ABSTRACT

A document processing apparatus includes: a memory that stores definition information that defines a process executed to document information representing a document, a sequence to execute the process, and a parameter used in the process; a holding unit that holds a parameter of an unexecuted process and a set value set to a parameter of an executed process corresponding to the parameter of the unexecuted process, with the definition information that the memory stores; and a display controller that controls a display to display the set value that the holding unit holds and the parameter in relation to each other.

### CROSS-REFERENCE TO RELATED APPLICATION

This application is based on and claims priority under 35 USC 119 from Japanese Patent Application No. 2009-151009 filed on Jun. 25, 2009.

### BACKGROUND

(i) Technical Field

The present invention relates to a document processing apparatus, a document processing method, a document processing system, and a computer readable medium.

(ii) Related Art

There has been conventionally known an art that enables a user to check a property of a document during the process of a set of procedures to the document in the document workflow system executing a set of procedures predetermined to the input document by displaying the property of the document.

### SUMMARY

According to an aspect of the present invention, there is provided a document processing apparatus including: a memory that stores definition information that defines a process executed to document information representing a document, a sequence to execute the process, and a parameter used in the process; a holding unit that holds a parameter of an unexecuted process and a set value set to a parameter of an executed process corresponding to the parameter of the unexecuted process, with the definition information that the memory stores; and a display controller that controls a display to display the set value that the holding unit holds and the parameter in relation to each other.

### BRIEF DESCRIPTION OF THE DRAWINGS

An exemplary embodiment of the present invention will be described in detail based on the following figures, wherein:

FIGS. 1A through 1C are block diagrams illustrating an exemplary embodiment of a document processing system including a document processing apparatus of the present invention;

FIGS. 2A and 2B are diagrams illustrating a process definition; and

FIG. 3A is a flowchart illustrating an analysis holding process that a calculation unit executes, and FIG. 3B is a flowchart illustrating a document process that a document processing apparatus executes.

### DETAILED DESCRIPTION

A description will now be given, with reference to the accompanying drawings, of an exemplary embodiment of the present invention.

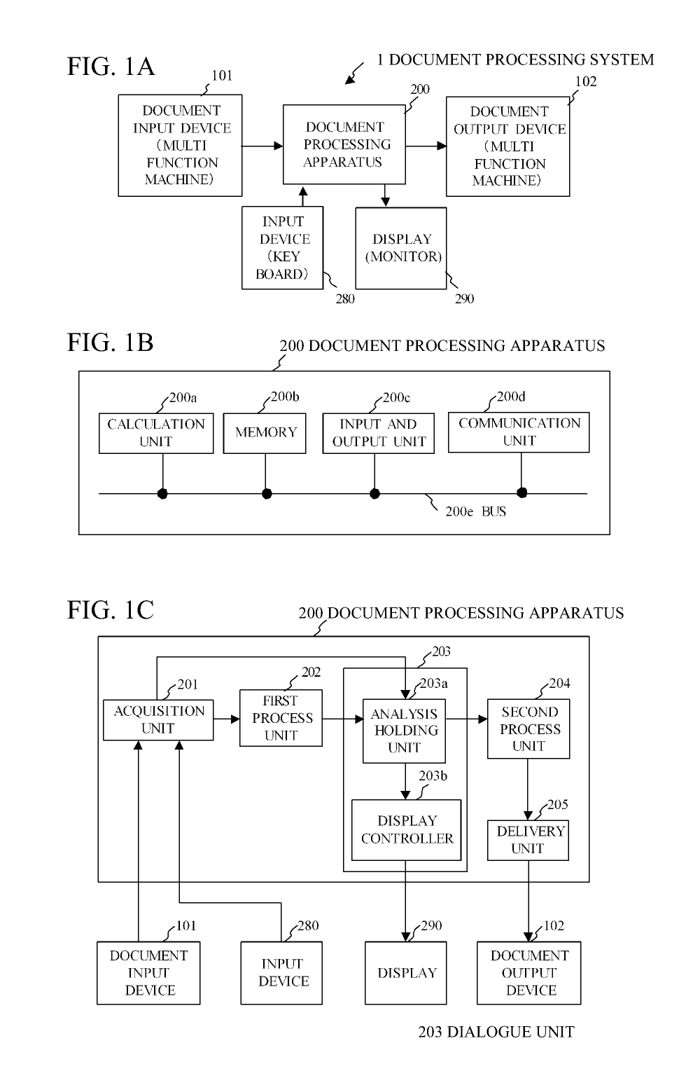

FIGS. 1A through 1C are block diagrams illustrating an exemplary embodiment of a document processing system including a document processing apparatus of the present invention.

Here, the document processing system is a system that performs a document process. The document process is a job process of which a process object is document information representing a document.

The job process means a procedure of a set of and multiple jobs predetermined. Here, the job is a process or a group of processes that a computer executes to implement predetermined functions. In addition, the procedure of jobs is defined by an execution sequence of jobs and a cooperation method between jobs. A transfer method between process object data used in executed and unexecuted jobs, and parameter values related to the process can be cited as a concrete example of the cooperation method between jobs. More specifically, the cooperation method between jobs includes a method to transfer the parameter value used in the executed job to the unexecuted job. Executing the job process means executing jobs according to the job process.

An analysis job, a process job, a transmission job, and the like can be cited as a concrete example of jobs. The analysis job includes a process to analyze document information, the process job includes a process to process document information, and the transmission job includes a process to transmit document information for example. The process to analyze document information includes a process to extract a variety of information from the document information. The process to extract information from the document information includes a process to extract character information representing characters written in a document from document image data that the document information represents, by OCR (Optical Character Read) process, and a process to extract information that a code represents from one-dimensional code image data such as a bar-code or two-dimensional code image data such as a QR (Quick Response) code that the document information represents for example. The process to process the document information includes a process to correct a tilt of a document image that the document information represents, a process to erect a document image that the document information represents, a process to convert a format of the document information, a process to encrypt the document information, a process to embed digital watermark in the document image that the document information represents, and a process to shield confidential matters from the document that the document information represents. The process to transmit the document information includes a process to send or deliver the document information with e-mail or FAX (facsimile), a file transfer process of the document information, and a process to output the document information to a printer.

A document processing system 1 illustrated in FIG. 1A is provided with a document input device 101, a document output device 102, a document processing apparatus 200, an input device 280, and a display 290.

The document input device 101 is composed of a multi function machine featuring multiple functions such as a document reading function, a document printing function, a reproducing function, a FAX communication function, and an information communication function, for example. Here, the document reading function is a function to read an original document optically, and generate the document information representing the read document as image data. The document printing function is, for example, a function to print the document that the document information represents on a print medium such as a print paper, a plastic card, a board, and a fabric. The reproducing function is a function to reproduce the document read by the document reading function by printing it with the document printing function. The FAX communication function and the information communication function are, for example, functions to receive and transmit the document information with TCP/IP (Transmission Control Protocol/Internet Protocol) or G3 protocol.

The document input device 101 inputs document information representing the document to the document processing system 1. More specifically, the document input device 101 acquires the document information by executing the document reading function, the FAX communication function, or the information communication function. Then, the document input device 101 stores the acquired document information in a predetermined shared folder of the document processing apparatus 200. The document input device 101 may be composed of a personal computer, and may input document information that a document creation software creates to the document processing system 1, for example.

The document output device 102 is composed of a multi function machine as well as the document input device 101. The document output device 102 receives the document information processed by the document processing apparatus 200 by executing the FAX communication function, or the information communication function. Then, the document output device 102 prints the document that the received document information represents by executing the printing function. The document output device 102 may be composed of a personal computer, and may control a display to display an electronic document processed by the document processing apparatus 200.

A description will now be given of the input device 280 and the display 290 before a description of the document processing apparatus 200. The input device 280 is composed of a keyboard or a pointing device (called a mouse hereinafter), for example. The input device 280 receives inputs of various information. The display 290 is composed of, for example, a liquid crystal panel, an organic EL (Electro-Luminescence), or a CRT (Cathode Ray Tube). The display 290 is controlled by the document processing apparatus 200, and displays various information.

The document processing apparatus 200 is composed of, for example, a server machine or a personal computer. The document processing apparatus 200 executes a document process that is a software process. By executing the document process, the document processing apparatus 200 executes the job to the document information that the document input device 101 inputs according to the predetermined process. Then, the document processing apparatus 200 delivers the document information to which the job is executed to the document output device 102.

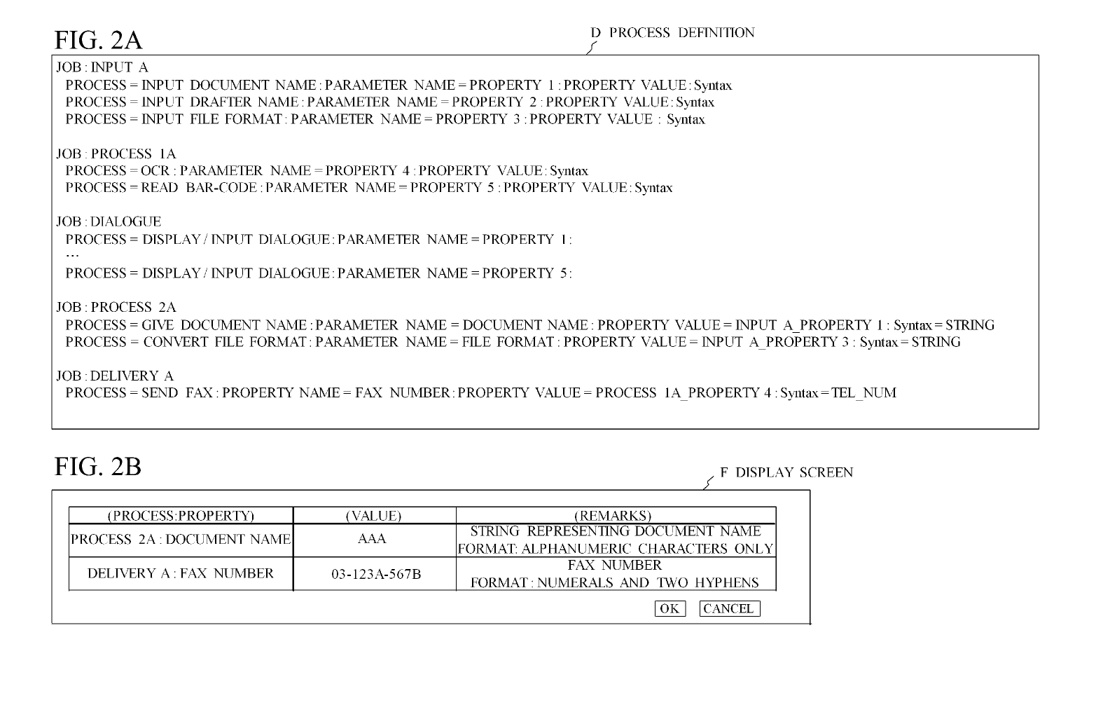

Here, with reference to FIG. 2A, a description will be given of a process definition that is definition information to define the job process that the document processing apparatus 200 executes.

A process definition D illustrated in FIG. 2A is a definition and description of a job process that the document processing apparatus 200 executes. Here, the process definition D defines jobs executed to the document information, a sequence to execute jobs, processes executed in the job, a parameter used in the process, and a restriction such as a format of the parameter and covered range of values in the job process. More specifically, the process definition D illustrated in FIG. 2A defines jobs that the document processing apparatus 200 executes as an input A job, a process 1A job, a dialogue job, a process 2A job, and a delivery A job described later. In addition, the process definition D defines the execution sequence of jobs as the input A job, the process 1A job, the dialogue job, the process 2A job, and the delivery A job, in that order.

More specifically, the process definition D defines that a document name is input by the user, and string data of the input document name is set as a parameter value “property 1” in the input A job. The process definition D defines that a drafter name and a file format name input by the user are set as parameter values “property 2” and “property 3” respectively. In addition, the process definition D defines that an OCR process executed to the image data as a process to process the input document information is executed in the process 1A job executed next to the input A job, and the extracted string data is set as a parameter value “property 4”. In the same manner, the process definition D defines that the string data acquired by reading the bar-code image in the image data of the input document information is set as a parameter value “property 5”. In addition, the process definition D defines that the parameter and its value that are data acquired by processes of the input A job and the process 1A job executed before the dialogue job are displayed in the dialogue job executed next to the process 1A job, and the process to enable the user to check and input corrections is executed as necessary.

The process definition D defines that the value set to the “property 1 of the input A job” is used for the parameter “document name” in executing a process to assign the document name to the document information in the process 2A job executed continuously after the dialogue job. This means that strings of the document name input as the “property 1 of the input A job” are assigned to the document information. Furthermore, the process definition D defines that the value set as the “property 4 of the process 1A job” is used for a parameter “FAX number” used in the delivery A job.

This means that the value set to the “property 4 of the process 1A job” is used as the destination to which the document information is sent with FAX.

The process definition D defines a parameter used in the job, and a restriction of the set value set to the parameter in the job. This restriction is expressed with syntax. This means that this restriction is used for the document processing apparatus 200 to determine whether the set value is against the restriction with a syntax analysis. More specifically, the restriction “string” imposed on the parameter of which the name is the document name used in the process 2A job means the restriction that prohibits the set value except the string.

In this manner, the restriction “TEL_NUM” imposed on the parameter of which the name is the FAX number used in the delivery A job means the restriction that prohibits the set value except values representing a FAX number. More specifically, the restriction “TEL_NUM” restricts the parameter to only the set value composed of characters and strings used for representing the FAX number. More specifically, when the usage area of the document processing apparatus 200 is JAPAN, the restriction “TEL_NUM” prohibits setting values except strings composed of two hyphens and ten numbers. Restrictions that the process definition D defines are not limited to these, may restrict the strings to the strings representing the number which starts with “+” for the international communication, and may restrict the parameter used as an e-mail address to the value which includes a character “@”.

The process definition D defines that the subsequent parameter refers to the value acquired in the previous process of the same parameter used in the previous process. More specifically, the set value set to the property 1 in the input A job executed before the process 2A job is substituted into the parameter of which the name is the document name used in the process 2A job. In this manner, the set value set to the property 4 in the process 1A job or the dialogue job executed before the delivery A job is substituted into the parameter of which the name is the FAX number used in the delivery A job.

A description will now be given of the document processing apparatus 200 with reference to FIGS. 1A through 1C. FIG. 1B is a hardware block diagram illustrating a composition of the document processing apparatus 200.

The document processing apparatus 200 as illustrated in FIG. 1B is provided with a calculation unit 200a, a memory 200b, an input and output unit 200c, and a communication unit 200d. The calculation unit 200a is composed of a CPU (Central Processing Unit) for example. The memory 200b is composed of a ROM (Read-Only Memory), a RAM (Random Access Memory), or a hard disk for example. The input and output unit 200c is composed of an A/D converter for example. The communication unit 200d is composed of a network card, for example. The calculation unit 200a through the communication unit 200d are coupled to each other with a bus 200e so that they are able to transact information.

A software process is implemented in that the calculation unit 200a reads a program stored in the memory 200b and executes calculation according to an execution sequence represented by the read program. Information representing a calculation result is written in the memory 200b by the calculation unit 200a. In addition, as necessary, the input and output unit 200c and the communication unit 200d input and output, or communicate information that they input and output, or communicate with various units and devices coupled to them as information of the calculation object of the calculation unit 200a and information representing the calculation result.

A composition of the document processing apparatus 200 will be described from the functional side with reference to FIG. 1C. FIG. 1C is a functional block diagram illustrating a composition of the document processing apparatus 200.

The document processing apparatus 200 is provided with an acquisition unit 201, a first process unit 202, a dialogue unit 203, a second process unit 204, and a delivery unit 205. The acquisition unit 201 is implemented in that the calculation unit 200a executes an acquisition process included in the input A job. The acquisition unit 201 acquires document information from the document input device 101. In addition, the acquisition unit 201 acquires a set value set to the parameter used in the execution of the job of which the object is document information. The acquisition unit 201 may set the acquired set value to the parameter that the process definition defines.

In this exemplary embodiment, the acquisition unit 201 acquires the set value from the input device 280 directly, but is not limited to this exemplary embodiment. For example, the acquisition unit 201 may acquire the set value that the input device to which a terminal device is coupled inputs from the terminal device to which the acquisition unit 201 is coupled via the communication network, indirectly.

The first process unit 202 is implemented in that the calculation unit 200a executes a first processing process included in the process 1A job. The first processing process is included in a process previous to a dialogue process described later. More specifically, the first processing process includes a process to process the document information. The first process unit 202 executes a predetermined process to the document information that the acquisition unit 201 acquires by using the parameter to which the set value that the acquisition unit 201 acquires is set. Here, the first process unit 202 may change the parameter value that the acquisition unit 201 sets to the parameter when executing the predetermined process to the document information. In addition, the first process unit 202 may set the value extracted from the document information to the parameter used for executing the predetermined process. More specifically, the document name of the document that the document information represents and the delivery destination of the document may be extracted from image data of the document information by executing the OCR process. In this exemplary embodiment, the first process unit 202 is described as it processes the document information, but is not limited to this exemplary embodiment. The first process unit 202 may execute any process as long as the process is the job that the process definition defines as the job executed before the dialogue job. More specifically, the first process unit 202 may execute a process to extract the predetermined information from the document information.

The dialogue unit 203 is implemented in that the calculation unit 200a executes a dialogue process included in the dialogue job. The dialogue unit 203 is provided with the analysis holding unit 203a and a display controller 203b. The analysis holding unit 203a is implemented in that the calculation unit 200a executes an analysis holding process included in the dialogue process. The analysis holding unit 203a analyzes a process definition that the memory 200b stores. The analysis holding unit 203a specifies the parameter related to both of executed and unexecuted jobs and the set value set to this parameter by analyzing the process definition. In this exemplary embodiment, contents of the process are represented by the process name, but are not limited to this exemplary embodiment. Then, the analysis holding unit 203a holds the value of the specified parameter set in the executed job (the previous job). The analysis holding unit 203a holds the restriction of the set value set to the specified parameter by analyzing the process definition. This means that the analysis holding unit 203a holds the specified parameter, the parameter value, and the restriction of the parameter in relation to each other. It is possible that the analysis holding unit 203a does not hold the parameter not used in the subsequent process even though the parameter is used in the process previous to the dialogue process.

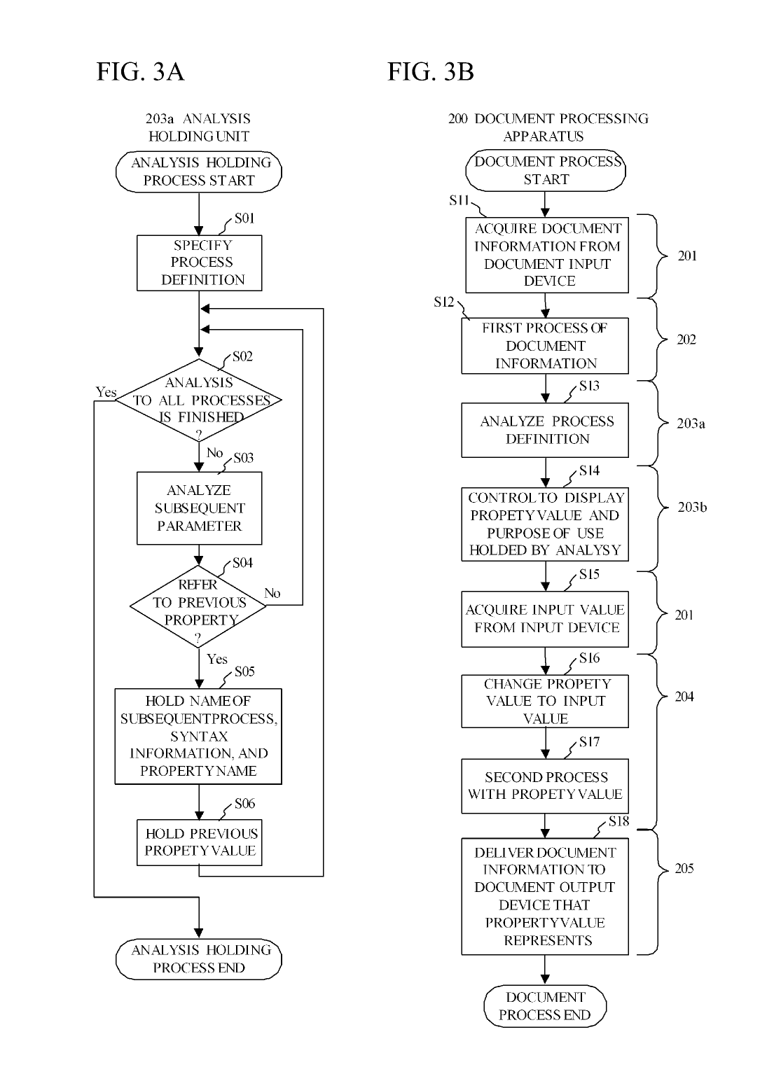

A description will now be given of the analysis holding process that the calculation unit 200a executes to implement the analysis holding unit 203a, with reference to FIG. 3A. FIG. 3A is a flowchart illustrating an analysis holding process that the calculation unit 200a executes.

The calculation unit 200a specifies a process definition that defines the job process to be executed (step S01). The process definition that defines the job process that the document processing apparatus 200 executes may be a process definition that the user of the document processing apparatus 200 selects from multiple process definitions stored in the memory 200b. Then, the calculation unit 200a determines whether it finishes the analysis described later to all processes (step S02). The calculation unit 200a ends the analysis holding process when it determines that the analysis to all processes is finished. The calculation unit 200a executes the procedure of a step S03 when it determines that the analysis is not finished.

In the step S02, when the calculation unit 200a determines that the analysis to all processes is not finished, it analyzes the process subsequent to the dialogue process (step S03). Here, the dialogue process includes the analysis holding process and the display control process. Thus, when the analysis holding process is executed, processes previous to the dialogue process are already executed, and processes subsequent to the dialogue process are not executed yet. Therefore, parameters used in processes subsequent to the dialogue process are parameters used in unexecuted processes. To be more specific about the procedure of the step S03, the calculation unit 200a selects the parameter that is not a process object from parameters used in unexecuted processes as the parameter which is a process object.

The calculation unit 200a determines whether the parameter that is a process object refers to the value of the same parameter processed in the previous process (step S04). The calculation unit 200a executes the procedure of a step S05 when it determines that the parameter that is a process object refers to the value of the same parameter processed in the previous process. The calculation unit 200a goes back to the step S02 and repeats the procedure above when it determines that the parameter that is a process object does not.

In the step S04, when the calculation unit 200a determines that the parameter that is a process object refers to the value of the same parameter processed in the previous process, it holds the value and Syntax information of the parameter that is the process object, and the name of the subsequent process that uses the parameter that is the process object (step S05). The Syntax information is restriction information that represents the restriction of the set value set to the parameter that is the process object. Then, the calculation unit 200a holds the set value already set to the parameter that is the process object in the previous process (step S06). Then, the calculation unit 200a goes back to the step S02 and repeats the procedure above.

A description will now be given of the composition of the document processing apparatus 200 with reference to FIG. 1C.

The display controller 203b is implemented in that the calculation unit 200a executes a display control process included in the dialogue job. The display controller 203b controls the display 290 to display the name of the subsequent process, the parameter name of the parameter used in the subsequent process, the subsequent property value to which the parameter refers, and Syntax information of the property value in relation to each other. This means that the display controller 203b makes the display 290 display what kind of jobs the parameter to which the set value that the user using the document processing apparatus 200 inputs with the input device 280 is set is used in, how the parameter is used, and what kind of restrictions is imposed on the parameter.

In addition, the display controller 203b controls the display 290 to display the state that the set value that the analysis holding unit 203a holds is against the restriction when the set value acquired from the input device 280 by the acquisition unit 201 is against the restriction represented by the restriction information that the analysis holding unit 203a holds.

The display controller 203b gets the display 290 not to display the process name above, the previous property value, and the like in regard to the parameter not used in the subsequent process even though the parameter is used in the process previous to the dialogue process.

Here, a description will be given of an example of a display screen that the display controller 203b makes the display 290 display, with reference to FIG. 2B. FIG. 2B is a diagram illustrating a display screen that the display controller 203b makes the display 290 display. The display screen illustrated in FIG. 2B is displayed by the software such as a web browser.

A display screen F illustrated in FIG. 2B displays a column indicating a process and a property name (hereinafter, called just a property name column), a value column, and a remarks column indicating a restriction and a comment. The property name column displays a name of an unexecuted process and a name of a parameter used in the unexecuted process in the same cell. The value column displays the set value set to the parameter of which the name is displayed in the property name column on the same line in the executed process. In addition, the cell of the value column acts as an input box. This means that the cell of the value column displays the set value of the parameter that the user of the document processing apparatus 200 inputs by operating the input device 280. The remarks column displays information of the restriction related to the set value, and information representing the purpose of the set value, which are defined as Syntax information.

More specifically, the display screen F illustrated in FIG. 2B represents the parameter to which the value “AAA” is set is used as the parameter representing the document name in the process 2A job unexecuted yet. The display screen F also represents that the parameter to which the value “03-123A-567B” is set is used as the parameter representing the FAX number in the delivery A job unexecuted yet. In this embodiment, a description will be given under the assumption that the value “03-123A-567B” is the FAX number extracted from the document information by the OCR process in the process 1A job. In addition, the user of the document processing apparatus 200 confirms that the extracted value “03-123A-567B” is used as the FAX number in the delivery A job unexecuted on the display 290. Then, as necessary, the user changes the value “03-123A-567B” to the FAX number representing the correct destination of the document information. The FAX number is necessary to be composed of numbers according to the restriction, but strings such as alphabetical characters “A” and “B” extracted by the OCR process exist in this case. Therefore, the user may input the correct number “03-1234-5678”.

The property name column or the value column may display the input restriction imposed on the parameter represented by the property name or the parameter to which the set value is set on a pop-up window.

The composition of the document processing apparatus 200 will be described with reference to FIGS. 1A through 1C.

The second process unit 204 is implemented in that the calculation unit 200a executes a second processing process included in the process 2A job. The second processing process is included in the process subsequent to the dialogue process. More specifically, the second processing process includes a process to process the document information as well as the first processing process above. The second process unit 204 executes the processes subsequent to the dialogue process to the document information that is the object of the process previous to the dialogue process with the parameter to which the set value that the acquisition unit 201 acquires from the input device 280 in the execution of the dialogue process is set. The second process unit 204 executes the subsequent process with the set value of the parameter set in the previous process or an initial value in regard to the parameter to which the user of the document processing apparatus 200 does not set the set value.

The delivery unit 205 is implemented in that the calculation unit 200a executes a delivery process included in the delivery A job. The delivery unit 205 delivers the document information that is the object of the process of the second process unit 204 to the destination that the parameter represents. In this exemplary embodiment, a description will be given under the assumption that the delivery unit 205 delivers the document information with the parameter to which the set value is set in the process previous to the delivery process. More specifically, the delivery unit 205 delivers the document information to the FAX number that the parameter to which the set value is set in the dialogue job (the input A job, the process 1A job, or the process 2A job) represents. The delivery unit 205 may deliver the document information to a mail account of the electric mail that the parameter represents. The delivery unit 205 may store the document information in a terminal device identified with IP address that the parameter represents or a shared directory of the document output device 102.

A description will be given of the document process that the document processing apparatus 200 executes, with reference to FIG. 3B. FIG. 3B is a flowchart illustrating a document process that the document processing apparatus 200 executes.

The document processing apparatus 200 acquires the document information from the document input device 101 (step S11). Then, the document processing apparatus 200 executes the first processing process above to the document information (step S12). Then, the document processing apparatus 200 analyzes a process definition that defines the job process executed to the document information as described above (step S13). Then, the document processing apparatus 200 controls the display 290 to display the set value of the parameter held by the analysis, the purpose of use of the parameter, the contents of the process using the parameter and the like.

Then, the user of the document processing apparatus 200 checks the display contents of the display 290. The user of the document processing apparatus 200 sets the set value to the parameter with the input device 280, or changes the set value set to the parameter. More specifically, it is often the case that the user of the document processing apparatus 200 does not know or does not know so well contents of the process definition. Therefore, the user determines whether the set value already set or to be set is appropriate in the context of contents of the subsequent process defined by the process definition, the purpose of use of the parameter in the subsequent process, and the restriction imposed on the parameter in the subsequent process, on the basis of display contents of the display 290. As the display 290 does not display the parameter used in the subsequent process, the user determines whether the set value of the parameter only used in the subsequent process is appropriate. Then, the user inputs the set value that the user thinks appropriate to the input device 280 by operating the input device 280.

Then, the document processing apparatus 200 acquires the input value from the input device 280 operated by the user (step S15). Then the document processing apparatus 200 changes the property value to the acquired input value (step S16). The document processing apparatus 200 executes the second processing process above with the changed property value (step S17). Then, the document processing apparatus 200 delivers the document information to the document output device 102 that the property value represents (step S18). The document processing apparatus 200 ends the document process.

In FIG. 3B, the procedures of the steps S11 and S15 correspond to examples of the acquisition process to implement the acquisition unit 201. The procedure of the step S12 corresponds to an example of the first processing process to implement the first process unit 202. The procedure of the step S13 corresponds to an example of the analysis holding process to implement the analysis holding unit 203a. The procedure of the step S14 corresponds to an example of the display control process to the display controller 203b. The procedures of the steps S16 and S17 correspond to an example of the second processing process to implement the second process unit 204. The procedure of the step S18 corresponds to an example of the delivery process to implement the delivery unit 205.

Programs that the document processing apparatuses 200 executes can be supplied by providing a magnetic disk, an optical disk, a semiconductor memory, or other recording media to which the program is stored, or delivering the program via the network.

Furthermore, a part of or all of functions that the document processing apparatuses 200 implements with the execution of the software process can be implemented with the hardware circuit. A part of or all of functions that the document processing apparatuses 200 implements with the hardware circuit can be implemented with the execution of the software process.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A document processing apparatus comprising:
a memory that stores definition information that defines a process executed to document information representing a document, a sequence to execute the process, and a parameter used in the process;
a holding unit that holds a parameter of an unexecuted process and a set value set to a parameter of an executed process corresponding to the parameter of the unexecuted process, with the definition information that the memory stores; and
a display controller that controls a display to display the set value that the holding unit holds and the parameter in relation to each other.

2. The document processing apparatus according to claim 1, wherein
the definition information defines the process, the parameter used in the process, and restriction information that indicates a restriction of a set value set to the parameter in the process,
the holding unit holds a set value and the restriction information in the unexecuted process in relation to each other, and
the display controller controls the display to display the set value that the holding unit holds and the restriction information in relation to each other.

3. The document processing apparatus according to claim 2, wherein the display controller controls the display to display the state that the set value is against the restriction that the restriction information indicates when the set value that the holding unit holds is against the restriction.

4. A computer readable medium causing a computer to execute a process, the process comprising:
storing definition information that defines a process executed to document information representing a document, a sequence to execute the process, and a parameter used in the process;
holding a parameter of an unexecuted process and a set value set to a parameter of an executed process corresponding to the parameter of the unexecuted process, with the stored definition information; and
controlling a display to display the set value held and the parameter in relation to each other.

5. A document processing method comprising:
storing definition information that defines a process executed to document information representing a document, a sequence to executes the process, and a parameter used in the process;
holding a parameter of an unexecuted process and a set value set to a parameter of an executed process corresponding to the parameter of the unexecuted process, with the stored definition information; and
controlling a display to display the set value held and the parameter in relation to each other.

6. A document processing system comprising:
a document input unit that inputs document information representing a document;
a memory that stores definition information that defines a process executed to the document information that the document input unit inputs, a sequence to execute the process, and a parameter used in the process;
a holding unit that holds a parameter of an unexecuted process and a set value set to a parameter of an executed process corresponding to the parameter of the unexecuted process, with the definition information that the memory stores; and
a display that displays the set value that the holding unit holds and the parameter in relation to each other.
